(19) United States
(12) Patent Application Publication
(10) Pub. No.: US 2014/0366584 A1
(43) Pub. Date: Dec. 18, 2014

(54) PROCESS FOR FORMING FIBERS FROM VITRIFIABLE MATERIALS

(71) Applicant: SAINT-GOBAIN ISOVER, Courbevoie (FR)

(72) Inventors: Stephane Maugendre, Precy Sur Oise (FR); Francois Szalata, Laigneville (FR); Richard Clatot, Fleurines (FR)

(73) Assignee: SAINT-GOBAIN ISOVER, Courbevoie (FR)

(21) Appl. No.: 14/368,984

(22) PCT Filed: Dec. 18, 2012
(86) PCT No.: PCT/FR12/52978

§ 371 Date: Jun. 26, 2014

(30) Foreign Application Priority Data
Dec. 28, 2011 (FR) 1162500

(51) Int. Cl. C03B 37/01; C03B 5/20; C03B 5/03

(52) U.S. Cl. CPC C03B 37/01; C03B 5/031; C03B 5/205
USPC 65/474

(57) ABSTRACT

A fabrication process of mineral fibers, including: introduction of raw materials into a circular furnace with electrodes; then fusion of the raw materials in the furnace to form a molten vitrifiable material; then outflow of the molten vitrifiable material from the furnace via a lateral outlet to supply a distribution channel; then outflow of the molten vitrifiable material via an orifice in the furnace bottom of the distribution channel to supply a fiber forming device; then transformation into fibers of the molten vitrifiable material by the fiber forming device, flow of molten vitrifiable material between the furnace and the distribution channel passing under a metal dam adjustable in height including an envelope cooled by cooling fluid current. Adjustment of the dam height allows temperature of the glass to be formed into fibers to be varied to bring the glass into a desired viscosity range for the fiber forming process.

The invention relates to a process of fabrication of mineral fibers comprising the fusion of vitrifiable materials in a circular furnace with electrodes, the supply of a distribution channel with these molten materials, then their transformation into fibers.

The furnace used in the framework of the invention is known as a cold-top furnace allowing vitrifiable materials to be molten by the heat generated by resistive heating using electrodes immersed in the vitrifiable materials. The solid charge of vitrifiable materials is carried by the top and forms an upper layer completely covering the bath of molten materials. According to the prior art, the molten materials are extracted by the furnace bottom or laterally via a spout and are fed into a distribution channel supplying fiber forming devices. The fiber forming is a continuous process directly after the fusion of the vitrifiable materials. When a spout is used between the furnace and the distribution channel, rapid wearing of the refractory materials forming the spout is observed, in particular the upper part of the latter. Indeed, in spite of the use of cooling systems allowing the attack of the refractory materials by the molten materials at high temperature to be limited, these refractory materials must generally be replaced sooner than the other elements made of refractory materials of the furnace. Such a replacement furthermore requires the shutdown of the furnace. Moreover, a simple spout is neither a means for regulating the flow nor a means for regulating the temperature of the molten material. The temperature of the molten material is indeed an essential parameter for obtaining a high quality fiber forming process. The correct temperature of molten material in the fiber forming process is first of all obtained by adjusting the electrical current delivered by the electrodes. The design of the distribution channel such as its length, its thermal insulation and its specific heating means also have an influence on this temperature. The regulation of the whole fiber forming process is particularly difficult and may require a long period of trial and error. This difficulty is all the greater as this type of furnace generally operates for relatively short-lived fabrication campaigns and the transition times (period for stabilization of the fabrication from the start) are therefore long compared to the operation time in continuous mode. This type of fabrication generally operates with outputs in the range between 5 and 100 tons per day. It is the passage of the glass in the fiber forming dies which limits the output. The transformation into fibers is therefore the determining step for the flow of glass through the whole process (output). This is why the height of the dam only regulates the temperature and not the flow. This type of furnace with relatively modest dimensions (oven bottom internal surface area in the range between 1 m² and 30 m²) is very flexible and can be easily stopped at any time depending on the circumstances. It can generally operate without stopping for between 24 hours and 6 months, or even longer.

U.S. Pat. No. 6,314,760 discloses a circular furnace with electrodes and a conical furnace base supplying a distribution channel, the flow of glass between the furnace and the canal going through a molybdenum tube surrounded by an envelope through which cooling water flows. This document does not offer any solution for regulating the flow of glass and the temperature of the glass exiting from the furnace.

U.S. Pat. No. 3,912,488 discloses a circular furnace with electrodes and a conical furnace base comprising an orifice for extraction of the molten materials from the apex of the cone of the furnace base, said orifice being cooled by a circulation of water.

The invention contributes to overcoming the aforementioned problems by offering an additional possibility of regulating the temperature of the molten vitrifiable material. It has indeed been observed that, in this type of circular furnace, a vertical temperature gradient existed in the vitrifiable materials, the hotter materials being at the top just under the crust of vitrifiable materials not yet molten, and the nearer to the furnace bottom, the cooler they are. It has also been observed that it was possible to act on the temperature of the flow of molten materials going from the furnace to the distribution channel by using the depth of a vertically mobile dam situated laterally with respect to the furnace, between the furnace and the distribution channel. The lower the dam, the lower is the temperature of the molten materials passing under it, and vice versa.

Thus, the invention relates to a process of fabrication of mineral fibers comprising the introduction of raw materials into a circular furnace with electrodes, then the fusion of the raw materials in said furnace in order to form a molten vitrifiable material, then the outflow of the molten vitrifiable material in the furnace via a lateral outlet from the furnace so as to supply a distribution channel, then the outflow of the molten vitrifiable material via an orifice on the furnace bottom of the distribution channel so as to supply a fiber forming device, then the transformation into fibers of the molten vitrifiable material by said fiber forming device, the flow of molten vitrifiable material between the furnace and the distribution channel passing under a metal dam being adjustable in height comprising an envelope cooled by a flow of cooling fluid.

The vertical temperature gradient in the molten materials in the furnace will be higher the more readily that the vitrifiable materials absorb infrared radiation. The presence of iron oxide in the molten charge contributes to the absorption in the infrared. Thus, the process according to the invention is particularly well suited when the molten material contains more than 2% by weight of iron oxide (sum of all the forms of iron oxide) and even more than 3% and even more than 4% by weight of iron oxide. Generally speaking, the molten material contains less than 20% by weight of iron oxide. The process according to the invention is notably well suited when the molten material comprises from 1 to 30% by weight of alumina, and even 15 to 30% by weight of alumina. For example, it may be used to melt glasses for fibers with compositions described in one or other of the documents WO99/57073, WO99/56525, WO00/17117, WO2005/033032, WO2006/103376, incorporated here by reference.

The ideal temperature for fiber forming depends on the composition of the molten material. Generally speaking, the idea is for its viscosity to be in the range between 25 Pa·s and 120 Pa·s. Thus, according to the invention, the height of the dam can be adjusted such that the viscosity of the molten vitrifiable material is included within this range. Indeed, the height of the dam has a direct influence on the temperature of the vitrifiable material and hence on its viscosity. The height of the dam is therefore determined (in other words adjusted) such that the viscosity of the molten vitrifiable material is in the range between 25 Pa·s and 120 Pa·s in the fiber forming device.

The invention is suited to the forming of fibers from glass or from rock.

The temperature of the molten vitrifiable material passing under the dam is chosen as being higher than the devitrification temperature of the vitrifiable material. Generally speaking, the temperature of the vitrifiable material passing under the dam is in the range between 850 and 1700° C. For a vitrifiable material comprising at least 15% by weight of alumina, notably 15 to 30% of alumina, the temperature of the vitrifiable material passing under the dam is generally in the range between 1200 and 1700° C. The height of the dam is therefore adjusted such that the molten material passing under it is in the correct range of temperature. The dam according to the invention therefore allows a true regulation of the process according to the invention.

The invention is suited to all types of glass or rock. However, the more readily the vitrifiable material absorbs infrared radiation (IR), the more advantageous the invention. Indeed, the greater the absorption of IR by the vitrifiable material, the more heat transfers are limited and the greater the thermal gradient observed from the furnace bottom to the crust of raw materials floating on top of the molten vitrifiable material. The furnace bottom is thus colder the more the vitrifiable material absorbs IR. This is favorable to the total lifetime of the furnace bottom. A vitrifiable material absorbing less IR is for example a glass of the borosilicate type. A glass absorbing more IR is for example an automobile glass used as a sun screen in sun roof applications.

The dam is made of metal and is hollow such that a cooling fluid can flow through its interior. The dam can be constructed from metal plates that are welded together. Advantageously, the welds are inside the dam. The metal of the dam can be steel such as AISI 304. The immersed part of the dam can be totally made from such a steel. Conduits are connected via the top of the dam to allow the entry and the exit of the cooling fluid. Advantageously, the cooling fluid is liquid water in the form of running water whose temperature prior to passage in the dam is generally in the range between 5 and 50° C., preferably between 20 and 40° C. (water that is too cold with a temperature below 10° would risk causing condensation of water onto the installation). The cooling fluid could be air. The dam generally has a height that is sufficient to potentially completely block the flow of molten materials between the furnace and the distribution channel. Advantageously, the cross section of the dam has a trapezoidal shape, in other words its two large faces can come closer toward the bottom. It is thus easier to retract the dam if the latter is trapped in solidified vitrifiable material. The width of the dam substantially corresponds to the width of the passage for the molten charge flowing toward the distribution channel, which substantially corresponds to the width of the distribution channel. The width of the passage for the molten vitrifiable material under the dam and of the dam itself is generally in the range between 20 and 60 cm (width measured transverse to the direction of flow of the vitrifiable material).

The furnace is circular. The bottom of the furnace may be flat or may comprise an inclined surface. The inclined surface of the furnace bottom allows the molten vitrifiable material to run toward the lowest point of the furnace bottom as it begins to melt. Indeed, it is advantageous to bring together the small volume of molten vitrifiable material at the start of the filling of the furnace in order to form a hot spot accumulating the heat. This allows the process to be instigated faster at the start of filling and has the effect of priming the operation of the furnace. The inclined surface may be that of an upside down cone whose apex is the lowest point of the bottom of the furnace. It may also take the form of an inclined plan whose intersection with the cylindrical wall of the furnace forms a curved line, which has a lowest point of the furnace bottom. Other shapes are possible, the idea being that the furnace bottom comprises a concave angle oriented upward toward which the molten vitrifiable material runs at the start of the filling of the furnace so as to accumulate. This angle can be formed where the furnace bottom and the side wall of the furnace meet. The raw materials are therefore preferably directed toward this angle at least at the start of the filling of the furnace. If this angle is not in a central position in the furnace bottom, initially, the solid raw materials may be channeled toward this angle, then when a sufficient level of molten vitrifiable material is reached, the solid raw materials are channeled more over the center of the furnace bottom. The solid raw materials may also be directed toward this concave angle of the furnace bottom when it is desired to put the furnace into standby (stoppage of the output, no supply with charge and keeping the furnace hot). Preferably, the electrodes are near to the place where the raw materials are introduced. Thus, if the latter are able to be introduced successively at several locations, it will be advantageous to be able to move the electrodes in order to make them follow the location of introduction of the raw materials.

The interior of the furnace is lined with refractory materials coming into contact with the vitrifiable materials, both on the furnace bottom and on the side wall. The side wall generally comprises an external metal envelope in contact with the ambient air. In general, this metal envelope comprises two partitions between which cooling water flows (system not shown in the figures). Electrodes are immersed in the vitrifiable materials from the top. These electrodes generally comprise a part made of molybdenum immersed in the vitrifiable materials and a part made of steel above the vitrifiable materials connected to an electrical voltage. Thus, the part of the electrodes in contact with the vitrifiable materials is generally made of molybdenum. It would seem that electrodes made of molybdenum progressively react with the iron oxide present in the vitrifiable materials promoting the presence of FeO to the detriment of Fe₂O₃, said FeO absorbing IR in particular, which goes in the direction of an increase in the temperature gradient from the furnace bottom to underneath the crust of raw materials. The introduction of the electrodes from above has several advantages with respect to the configuration according to which the electrodes would go through the furnace bottom. Indeed, the passage through the furnace bottom would require the formation of electrode blocks making the link between the electrode and the furnace bottom, which blocks are particularly difficult to produce due to the fact that the furnace bottom is also cooled by a metal envelope. An electrode in the furnace constitutes a hotter region and the electrode blocks made of ceramic refractory material would be corroded particularly rapidly. In addition, immersing the electrodes from the top favors the creation of a temperature gradient climbing from the bottom to the top, owing to the fact that the electrodes heat at the top, combined in addition with the formation of FeO preferentially around the electrodes, hence also at the top. The number of electrodes is adapted according to the size and to the output of the furnace. The furnace is not generally equipped with means for stirring the vitrifiable materials (no mechanical stirrer nor immersed burner) except potentially of the bubbler type. The furnace is equipped with means for introduction of the vitrifiable materials. These are generally in powder form, or in granulated form, generally up to a diameter of 10 mm. The vitrifiable materials are distributed uniformly over the whole inside surface of the furnace in order to form a crust covering the molten materials. As a means of introduction of the vitrifiable materials, a cone rotating above the inside surface of the furnace may be used. The vitrifiable materials are made to fall onto the rotating cone whose rotation projects them uniformly over the whole inside surface of the furnace. The vitrifiable materials not yet molten form a crust on the surface above the molten vitrifiable materials. This crust forms a thermal screen limiting the heat losses from the top. Thanks to this, the top of the furnace can be simply made of boiler steel, without any particular means of cooling. The inside surface area of the furnace is generally in the range between 1 and 25 m². In operation, the depth of vitrifiable materials (molten+non-molten) is generally in the range between 20 and 60 cm. The output in molten vitrifiable materials can generally be in the range between 5 and 100 tons per day.

The distribution channel comprises at least one orifice in its furnace bottom. It may comprise 2 or 3 or more of them depending on the number of fiber forming devices to be simultaneously supplied. The thread of molten vitrifiable materials falling through this orifice is subsequently oriented toward a fiber forming machine.

The transformation into fibers can be carried out by a device known as an internal centrifugation device. The principle of the method of internal centrifugation is itself well known to those skilled in the art. Schematically, this method consists in introducing a thread of molten mineral material into a centrifuge, also referred to as fiber forming plate, rotating at high speed and having around its periphery a very large number of orifices via which the molten material is projected in the form of filaments under the effect of the centrifugal force. These filaments are then subjected to the action of an annular extrusion current at a high temperature and speed running along the wall of the centrifuge, which current thins it and transforms it into fibers. The fibers formed are driven by this gaseous extrusion current toward a receiving device generally formed by a strip being permeable to gas. This known method has been the subject of many improvements, notably those disclosed in the European patent applications No EP0189534, EP0519797 or EP1087912.

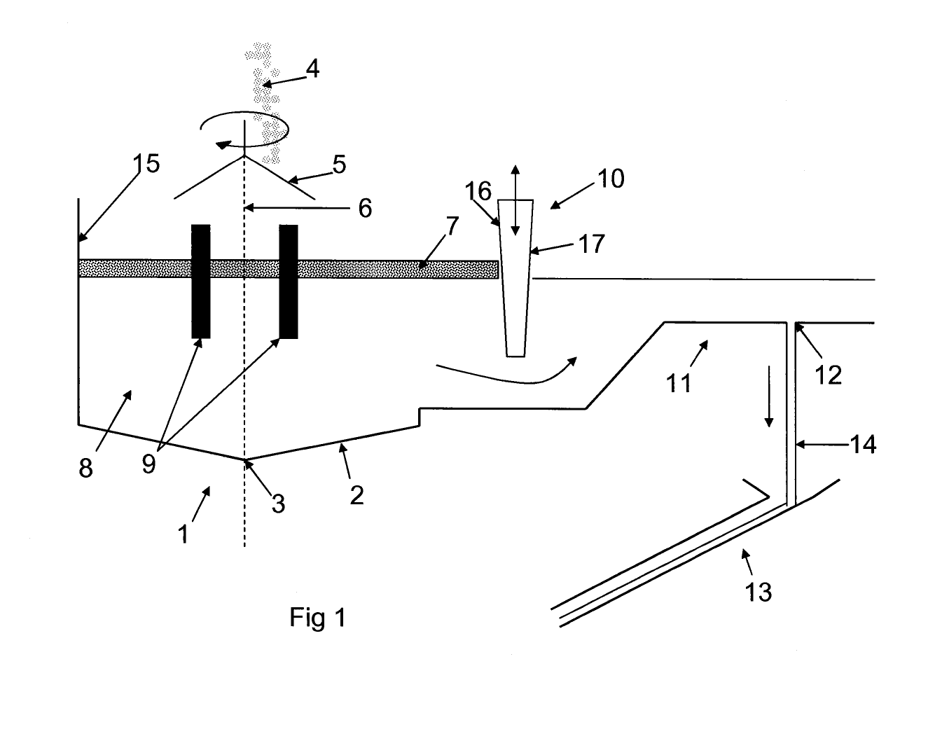

FIG. 1 shows the elements allowing the process according to the invention to operate in continuous mode from the fusion up to the fiber forming. A circular furnace 1 comprising a furnace bottom 2 comprising an inclined surface and a side wall 15 of the cylindrical type is supplied with vitrifiable materials 4 falling onto a metal cone 5 rotating about a vertical axis 6. This rotation allows the vitrifiable materials to be distributed over a larger surface area around the central axis 6. The inclined surface is part of a cone whose apex 3 is turned downward, forming a concave angle turned upward. The vitrifiable materials not yet molten form a crust 7 on the surface before melting and supplying the bath 8 of molten materials. The electrodes 9 produce the calories required for the fusion of the vitrifiable materials. The molten materials leave the furnace 1 by passing under the dam 10 with adjustable height and are cooled by a circulation of water. They subsequently arrive in the distribution channel 11 having orifices 12 (a single orifice is shown, where other orifices may be present further along to the right of the channel). They flow through the orifices 12 so as to form a thread 14 and fall into a trough 13 so as to subsequently supply a fiber forming device not shown. The dam 10 has a trapezoidal cross section (trapezium parallel to the plane of the figure which can be seen in the latter), in other words its largest sides 16 and 17 come closer toward the bottom.

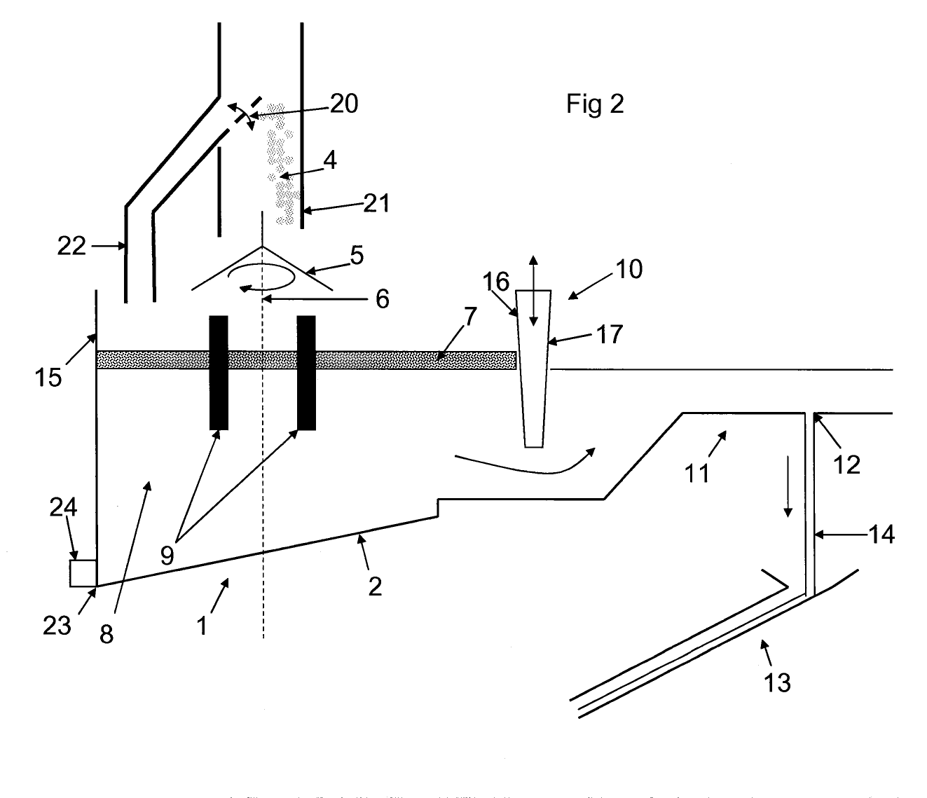

FIG. 2 shows the elements allowing the process according to the invention to operate in continuous mode from the fusion up to the fiber forming. All the same elements as in FIG. 1 are seen except that the furnace bottom 2 here takes the form of an inclined plane. The intersection of this furnace bottom 2 with the cylindrical wall 15 forms a curved intersection comprising a lowest point 23. The meeting point of the furnace bottom and of the side wall forms, at this lowest point, an angle being concave upward capable of receiving the molten vitrifiable material. A by-pass system 20 allows the raw materials to be oriented either toward a conduit 21 distributing the latter centrally above the cone 5, or toward a conduit 22 distributing these vitrifiable materials near to the lowest point 23 of the furnace bottom 2. The distribution by the conduit 22 takes place at the start of the filling of the furnace in such a manner as to accumulate a maximum amount of molten material in the corner 23 as quickly as possible. This accumulation of a small quantity of the molten materials at the start of the process allows the furnace to be primed. When the raw materials are engaged via the conduit 22 close to the vertical passing through the lowest point 23 of the furnace bottom, the electrodes 9 are also displaced, horizontally, so as to be located near to a vertical passing through the lowest point 23. Where required, a drainage plug 24 allows the furnace to be drained.

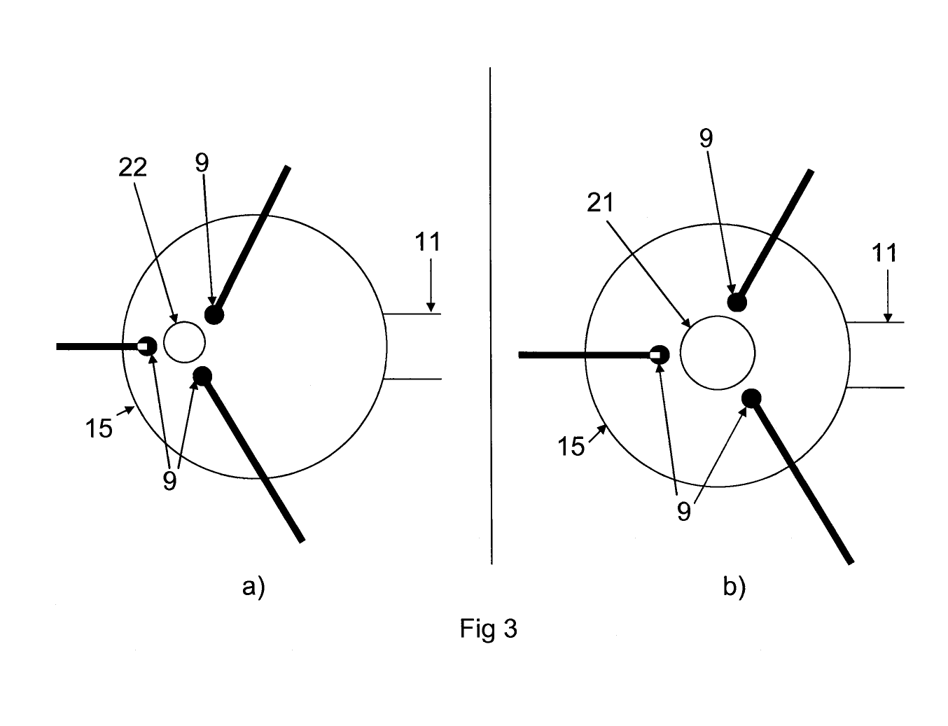

FIG. 3 shows the relative positions of the device for distribution of the raw materials and of the electrodes, in a top view, for the furnace in FIG. 2. The cylindrical wall 15 of the furnace and the distribution channel 11 can be seen. At the start of the filling (FIG. 3a)), the raw materials are introduced via the closest possible conduit 22 above the lowest point 23 (see FIG. 2). The electrodes 9 are situated as near as possible above this lowest point 23. In a continuous production process (FIG. 3b)), the raw materials are introduced via the conduit 21 in the center of the furnace. The electrodes 9 have been moved so as to surround the center of the furnace.

### EXAMPLES

Powdered raw material of the oxide type is introduced into a furnace of the type of that shown in FIG. 1 so as to form the glass charge comprising:
Silica: 43%
Alumina: 21%
Iron oxides: 6%
CaO+MgO: 17%
Na₂O+K₂O: 11%
TiO₂: 0.7%

A power of 630 kilowatts is supplied via electrodes. The height of the dam was varied and the temperature was measured for various heights in continuous mode and for a constant output of 10 tons per day. The table 1 hereinbelow presents the results for various distances between the furnace bottom and the lowest point of the dam.

TABLE 1

| | Temperature of the glass |
|---|---|
| Height under dam | just after the dam |
| 120 mm | 1350° C. |
| 140 mm | 1410° C. |
| 150 mm | 1450° C. |

1-16. (canceled)

17. A process of fabrication of mineral fibers, comprising:
introduction of raw materials into a circular furnace with electrodes;
then fusion of the raw materials in the furnace to form a molten vitrifiable material;
then outflow of the molten vitrifiable material in the furnace via a lateral outlet from the furnace to supply a distribution channel;
then outflow of the molten vitrifiable material via an orifice on the furnace bottom of the distribution channel to supply a fiber forming device;
then transformation into fibers of the molten vitrifiable material by the fiber forming device;
wherein the flow of molten vitrifiable material between the furnace and the distribution channel passes under a metal dam that is adjustable in height including an envelope cooled by a flow of cooling fluid.

18. The process as claimed in claim 17, wherein the molten vitrifiable material comprises more than 2% by weight of iron oxide.

19. The process as claimed in claim 18, wherein the molten vitrifiable materials comprise more than 3% or more than 4% by weight of iron oxide.

20. The process as claimed in claim 17, wherein the molten vitrifiable material comprises less than 20% by weight of iron oxide.

21. The process as claimed in claim 17, wherein the molten vitrifiable material passing under the dam has a temperature greater than its devitrification temperature.

22. The process as claimed in claim 17, wherein the molten vitrifiable material passing under the dam has a temperature in a range between 850° C. and 1700° C.

23. The process as claimed in claim 17, wherein the molten vitrifiable material comprises 1% to 30% of alumina.

24. The process as claimed in claim 23, wherein the molten vitrifiable material comprises 15% to 30% of alumina.

25. The process as claimed in claim 24, wherein the molten vitrifiable material passing under the dam has a temperature in a range between 1200° C. and 1700° C.

26. The process as claimed in claim 17, wherein the dam has a width in a range between 20 and 60 cm.

27. The process as claimed in claim 17, wherein the bottom of the furnace has a surface area in a range between 1 and 25 m².

28. The process as claimed in claim 17, wherein output of the furnace is in a range between 5 and 100 tons per day.

29. The process as claimed in claim 17, wherein the height of the dam is adjusted such that viscosity of the molten vitrifiable material is in a range between 25 Pa·s and 120 Pa·s in the fiber forming device.

30. The process as claimed in claim 17, wherein the electrodes are submerged from above in the vitrifiable materials.

31. The process as claimed in claim 17, wherein a part of the electrodes in contact with the vitrifiable materials is made of molybdenum.

32. The process as claimed in claim 17, wherein the transformation into fibers determines an output.
